(19) United States
(12) Patent Application Publication
(10) Pub. No.: US 2024/0208834 A1
(43) Pub. Date: Jun. 27, 2024

(54) APPARATUS AND METHOD FOR PRODUCING PURIFIED CALCIUM CARBONATE

(71) Applicant: Avgo Biotech Ltd, Grantham (GB)

(72) Inventors: Carole Celia PASHLEY, Nottingham (GB); Graham James HICKMAN, Nottingham (GB); Michael Douglas KEAST, Penrith (GB); Andrew Laurence STACEY, Grantham (GB); David BELTON, Nottingham (GB)

(21) Appl. No.: 18/557,553

(22) PCT Filed: Apr. 28, 2022
(86) PCT No.: PCT/EP2022/061358

§ 371 Date: Oct. 26, 2023

(30) Foreign Application Priority Data
Apr. 29, 2021 (GB) 2106141.1

(51) Int. Cl. C01F 11/18

(52) U.S. Cl. CPC C01F 11/185; C01P 2006/80

(57) ABSTRACT

A method for separating membrane from an avian eggshell comprising the steps of providing pieces of egg shell having attached membrane, contacting the pieces of egg shell having attached membrane with a carbonic anhydrase enzyme or an acidic aqueous medium, applying physical force to the pieces of egg shell having attached membrane, and separating the pieces of egg shell from the detached membrane. A method of producing purified calcium carbonate comprising the steps of; providing impure calcium carbonate material, contacting the impure calcium carbonate material with an aqueous acid to produce carbon dioxide and an aqueous product mixture comprising a calcium salt, adding an aqueous base to the aqueous product mixture, adding a carbonate source to the aqueous product mixture to produce calcium carbonate and a salt by-product, and precipitating purified calcium carbonate.

### BACKGROUND

The present invention relates to a method and apparatus for efficiently and simply separating eggshell from its membrane, maintaining the size of the membrane fragments. It particularly refers to a method of cleanly separating and purifying eggshell from its membrane. The separated eggshell or other impure calcium carbonate material can be used to produce purified calcium carbonate.

In the UK over 150,000 tonnes of eggs are processed into egg products every year. These egg products include egg white (predominantly albumen) and the egg yolk. They are used in the food industry in products such as Yorkshire puddings, meringues, mayonnaise and for cake baking. They can also be dried, providing greater stability for a very unstable material.

Up until the beginning of 2020 the egg processing sector in the UK and Europe was growing at a rate of approximately 10% per year.

“Cracked” eggshells are subjected to further processing, being spun to remove residual egg white, which is typically collected as Category 3 waste and sold into the pet food industry. The remaining shell is regarded as a waste product.

Across Europe over 250,000 tonnes of eggshells are generated from the egg cracking process. The current state of affairs is for this waste to be either used as fertilizer (spread on the land), as a feed ingredient or sent to landfill. In the latter case the processors are charged by specialist waste disposal firms over £100/tonne. A typical processor producing 1,500 tonnes of waste a year would incur costs of over £150,000/year.

This is not only directly costly to the egg processors, but also makes them less resilient to low-cost imports and economic depression. Landfill, while being a convenient way of disposal has a major environmental impact—producing large amounts of CO₂, SO₂ and phosphates which have detrimental effects on the land, air and lead to eutrophication of water courses. Typically, 1 tonne of landfilled eggshells would produce over 250 kg CO₂. Current pressures from the public and major corporate entities mean that this approach is not sustainable and if carried out will become more expensive and unacceptable.

An avian eggshell, such as a chicken eggshell, is made up of two major components—the inorganic, mineral shell and the organic membrane on its inside, next to the egg itself. The former, mineral, comprises predominantly calcium carbonate, while the latter, the membrane, is made up of proteinaceous fibres. The membrane being attached to the inorganic shell through a series of protuberances, papillae. Both of these materials have inherent value, through conversion for use in other industries.

The pharmaceutical and supplements industries commonly use calcium carbonate in their products—tablets, capsule and gummies. Material in the pharmaceutical and supplements markets is predominantly mined and is often sourced from Asia. This presents a number of issues for pharmaceutical manufacturers:
Mining is environmentally unfriendly, leaving major scarring of the landscape and having a large carbon footprint—every tonne of material mined can produce 440 kg of CO₂, a leading green-house-gas.
Mined material is subject to the vagaries of nature. Mined calcium carbonate is consistently found to be contaminated with toxic heavy metals, such as Mercury, Arsenic, Lead and Cadmium. This leads to either batch rejection or costly cleaning-up processes.
Materials mined in Asia and transported to the west carry a high carbon footprint, typically 330 kg CO₂/tonne of calcium carbonate.
Heavy duties charged for import into the UK and for export into Europe of goods derived from Asian raw materials.

These companies are becoming more and more aware of the need to meet stricter environmental and corporate social targets. Sustainability and environmental targets are becoming normal and will envelope the issues around sourcing calcium carbonate.

Eggshells are a natural and sustainable source of calcium carbonate which is low in toxic heavy metals. Other naturally and sustainably sourced eggshell calcium carbonates lack the purity to meet the requirements of the pharmaceutical industry, being high in other residual metals or biological materials—preventing them from meeting either food and pharmaceutical standards.

There exists a need for improved methods to process egg shells. There exists a need for methods to provide purified calcium carbonate.

### SUMMARY

According to the present invention there is provided a method for separating membrane from an avian eggshell comprising the steps of;
providing pieces of eggshell having attached membrane,
contacting the pieces of eggshell having attached membrane with a carbonic anhydrase enzyme in an acidic aqueous medium,
applying physical force to the pieces of eggshell having attached membrane, and
separating the pieces of eggshell from the detached membrane.

Preferably, physical force is applied to the pieces of eggshell using an auger and/or a pump; such as a transfer auger, progressive cavity pump, open impellor pump and/or screw impeller pump.

Conveniently, the detached membrane is separated from the pieces of eggshell by gravity, filtration and/or centrifugation.

Advantageously, the detached membrane is collected by flotation in an aqueous medium containing carbon dioxide.

According to the present invention, there is provided a method of producing purified calcium carbonate comprising the steps of;
providing impure calcium carbonate material,
contacting the impure calcium carbonate material with an aqueous acid to produce carbon dioxide and an aqueous product mixture comprising a calcium salt,
adding an aqueous base to the aqueous product mixture,
adding a carbonate source to the aqueous product mixture to produce calcium carbonate and a salt by-product, and
precipitating purified calcium carbonate.

Advantageously, the aqueous acid is hydrochloric acid, the calcium salt is calcium chloride, the aqueous base is sodium hydroxide, the carbonate source is sodium carbonate and the salt by-product is sodium chloride.

Preferably, the salt by-product produced by the addition of the carbonate source is used to generate the aqueous base and the aqueous acid.

Conveniently, carbon dioxide produced by contacting the impure calcium carbonate material with the aqueous acid is reacted with a base to generate the carbonate source.

Advantageously, impurities are precipitated and/or filtered from the aqueous product mixture; preferably in a continuous oscillatory baffled reactor.

Preferably, purified calcium carbonate is precipitated from the aqueous product mixture in a continuous oscillatory baffled crystalliser.

Conveniently, the impure calcium carbonate material is biogenic calcium carbonate material; preferably wherein the biogenic calcium carbonate comprises avian eggshells, marine biogenic material, mollusc shells or fossil biogenic material; more preferably wherein the marine biogenic material comprises mollusc shells and/or crustacean shells.

Preferably, the avian eggshells are chicken eggshells.

Conveniently, the avian eggshells are produced according to the method of the invention.

According to the present invention, there is provided an apparatus for separating membrane from an avian eggshell comprising a vessel for contacting pieces of eggshell having attached membrane with a carbonic anhydrase enzyme an acidic aqueous medium, means for applying physical force to the pieces of egg shell having attached membrane, and means for separating the pieces of egg shell from the detached membrane.

According to the present invention, there is provided an apparatus for producing purified calcium carbonate from impure calcium carbonate material, comprising a vessel for contacting the impure calcium carbonate material with an aqueous acid to produce carbon dioxide and an aqueous product mixture comprising a calcium salt, means for adding an aqueous base to the aqueous product mixture, means for adding an aqueous base to the aqueous product mixture to produce calcium carbonate and a salt by-product, and means for precipitating purified calcium carbonate.

### BRIEF DESCRIPTION OF THE DRAWINGS

The invention will now be described with reference to the figures, in which;

FIG. 1 is a schematic view of a system for separating membrane from avian eggshell, and

FIG. 2 is a schematic view of a system for producing purified calcium carbonate from biogenic calcium carbonate.

### Detailed Description

The present invention relates to a process and equipment to separate eggshells and their membranes—producing a high purity eggshell calcium carbonate and eggshell membrane retaining a large size (near intact). Thus, meeting needs for potential applications of these materials in diverse industries. The invention also reduces the impact of eggshell waste on the environment.

The invention also aims to make use of all of the process's co-products, either selling minor products or reusing process co-products. This increases circularity, with little need for costly input chemicals and very little waste. This reduces the impact of the process on the environment.

Bearing the aforementioned in mind, the process and equipment are separated into two phases:
A. A separation and consolidation phase, and
B. A purification and re-use phase

### A. Phase 1

This system contains an acidic aqueous medium or water containing enzymes or pass through a packed section containing immobilized enzymes that solubilizes carbon dioxide controlling the acidity of the water at a slightly acid pH, leading to the breakdown/dissolution of the mineral mammillae of the shell attaching to the membrane. A slightly acidic pH and/or the presence of CO₂ bubbles also act as a bactericide or to inactivate bacteria and viruses.

Eggshells are deposited on a flat collection tray or shallow tank, containing the water, to channel cleaved eggshells into a transfer device. Sprays may be used to assist sinking eggshells into the transfer device. This transfer device contains a transfer auger which leads on to a progressive cavity pump or open impellor pump or screw impeller pump and suitably formed transfer tubing, leading to a settling tank or cyclone separator.

The mineral part of the eggshell and membrane will be encouraged to detach in this set up.

Separation occurs by flowing water carrying the light membrane whilst heavy mineral parts of the shells separate by gravity or centrifugal force.

The mineral part of the eggshell is transferred to a macerater which produces consistently sized fragments. These fragments are dewatered with recovered water being returned to the start of the process, egg collection, via a filtration system.

The membrane is transferred to a membrane collection device—comprising a tank of “clean” water which is aerated by CO₂, making the solution slightly acidic, acting as a bactericide/virus inactivator, with a circulating system operating under greater pressure, supersaturating this stream with CO₂ or other gas. On return to the tank the excess CO₂ or other gas will disengage as microbubbles which will tend to form on the surface of the fragments of membrane. The rising of these microbubbles lifts the membranes to the surface of the tank where they are transferred for packing via a suitable dewatering/drying system. The water is returned to the start of the process (egg collection), via a suitable filtration system.

Membrane is transferred to suitable processing facilities outside of the scope of this invention, while the mineral part of the eggshell is transferred to phase 2 of the invention.

Disengaged CO₂ or other gas can be collected and recompressed for reuse if economically feasible.

### B. Phase 2

Eggshells from phase 1 are deposited in a dispensing hopper. These eggshells are transferred into a reaction vessel.
a) The reaction vessel contains HCl (recycled from step (j) below), which will dissolve the eggshells, producing CO₂ and CaCl₂.
b) The CO₂ gas will be collected, for use in generating input chemicals (k.2).
c) The CaCl₂ solution will be pumped through a filtration system to collect any remaining biologicals and incompletely processed shell. The eluant can be concentrated providing water, which is returned to the reaction vessel (a) and concentrated CaCl₂, which passes down the process (d)
d) Concentrated CaCl₂ has NaOH (recycled from k) added which allows the precise precipitation of contaminating magnesium, as Mg(OH)₂. This is also advantageous as the precipitation of the unwanted Mg(OH)₂ helps to remove any remaining membrane as sediment in the precipitation step (in the case of using avian eggshell as the biogenic calcium carbonate starting material). This removes impurities and avoids the use and cost of additional reagents.
e) The output of this reaction is passed through a cross flow filter or other filter to remove the solid Mg(OH)₂.
f) The eluant, CaCl₂ solution can be further concentrated to reduce size and cost of plant downstream. Addition of Na₂CO₃ (generated in k.2) to this CaCl₂ solution leads to the precise precipitation of CaCO₃.
g) The CaCO₃ is collected, dewatered and dried under GMP conditions.
h) The eluant, NaCl solution, can be concentrated.
i) The NaCl solution is subjected to an electrolytic process, producing HCl and NaOH.
j) The former, HCl, is returned to the beginning of phase 2 to dissolve the eggshell (a).
k) While the latter, NaOH, is either used to; 1) precipitate out magnesium hydroxide (d) or 2) to capture the CO₂ produced earlier (a) leading to the generation of Na₂CO₃, for use in precipitating out CaCO₃ (f)

A. Phase 1—Separation and Consolidation—a system for separating eggshells from the membrane, providing large sized membrane pieces and consistently sized eggshell pieces.

B. Phase 2—Purification and Re-use—a system for the purification of the eggshell CaCO₃ and recycling co-products for use as inputs to the process.

The structure of avian eggshells, especially chicken eggshells, is known. On the inside of the eggshell there are two membranes; one surrounds the egg albumin, the other is attached to the wall of the shell. There is an air pocket between the two membranes located at the rounder end of the egg.

On the surface of the outer membrane are delicate protein filaments which have wart-like mammillae on their surface on which calcium carbonate crystallizes as the eggshell forms creating the first layer of the mineral part of the shell called the mammillae layer about 70 microns thick.

This transitions into the main layer of the shell, called the palisade layer is mostly calcium carbonate (typically with about 3% magnesium carbonate) the crystals of these minerals are held together with a matrix of further proteins. The outermost thin calcium carbonate layer is made of crystals oriented vertically, which are coated with a protein layer (cuticula), such that the surface of the egg is smooth with a silky sheen. Pigments producing colour are restricted to this uppermost calcium carbonate layer and the cuticula. As well as magnesium, the shell can contain other potentially undesirable metals.

A progressing cavity pump is a positive displacement pump employing a rotor and stator assembly to create temporary chambers to draw fluid into, which ‘progress’ through the pump resulting in the fluid being expelled through the discharge port. In this case a progressive cavity pump can be used that is sized with a chamber just smaller than the eggshell diameter.

In use the eggshell will be compressed equally around its diameter as it passes through the pump. It is hypothesized that this compression from the outside of the shell will crack the shell without tearing the membranes attached to the inside of the shell.

Minimising tearing of the membrane increases the efficiency of separating the membrane from the shell.

Being ‘positive displacement’, these pumps will naturally rise to provide just sufficient pressure for any length /configuration of transfer tubing.

Similarly, a specific size of pipework can be chosen to create space for eggshells to pass whilst experiencing the optimum type of turbulent flow to draw the mineral part of the eggshell away from the inner membranes. For example, using transfer tubing sized at 2.5″ (internal diameter 56 mm) allows for 40 mm diameter eggshells to pass through without suffering further compression and membrane tearing forces that would be caused by the shells dragging against the pipe wall.

The pump has a variable speed controller and this can be set so that optimum turbulent conditions can be created in the discharge pipework to separate the pre-cracked mineral part of the eggshell from the inner membranes whilst avoiding tearing of the inner membranes.

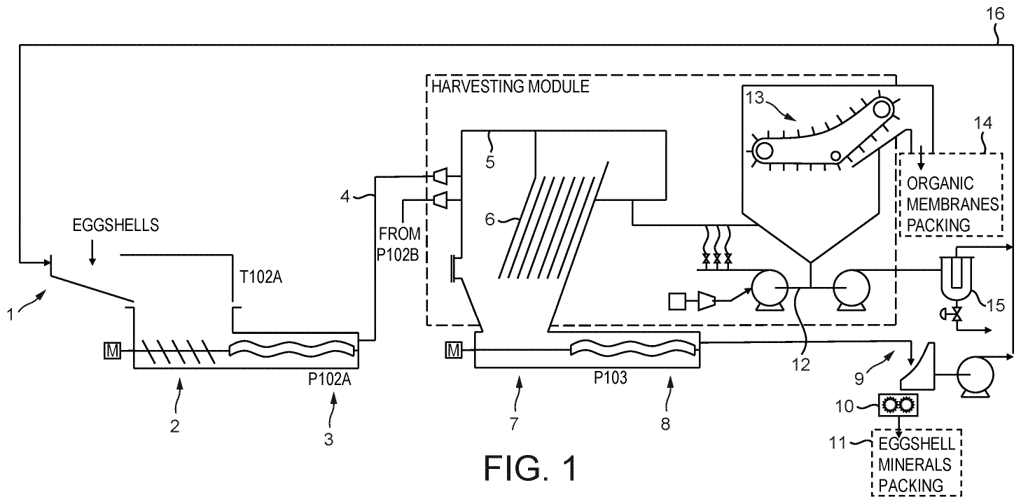

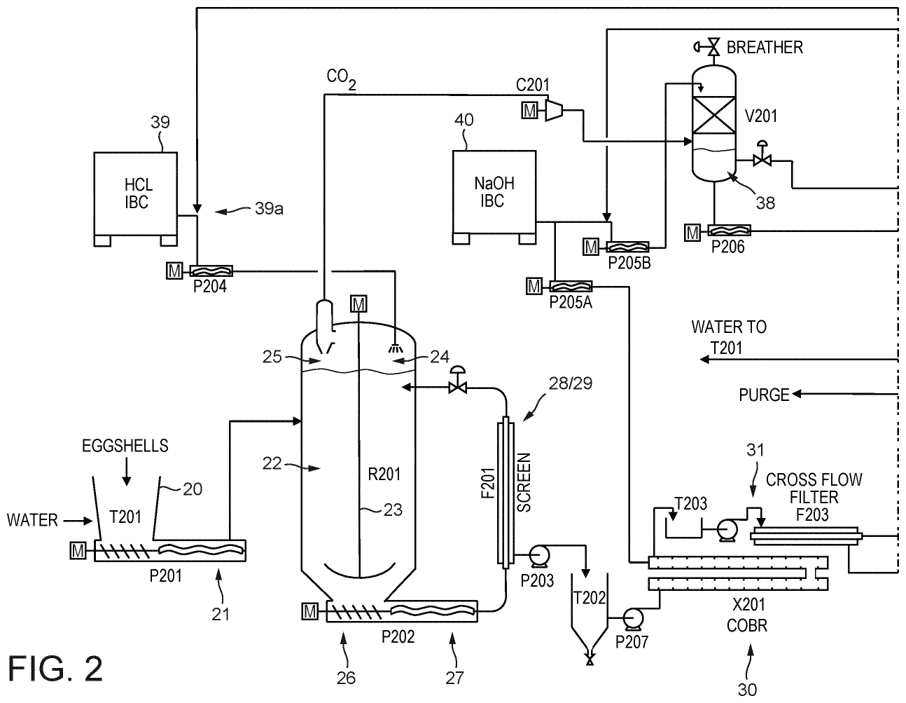

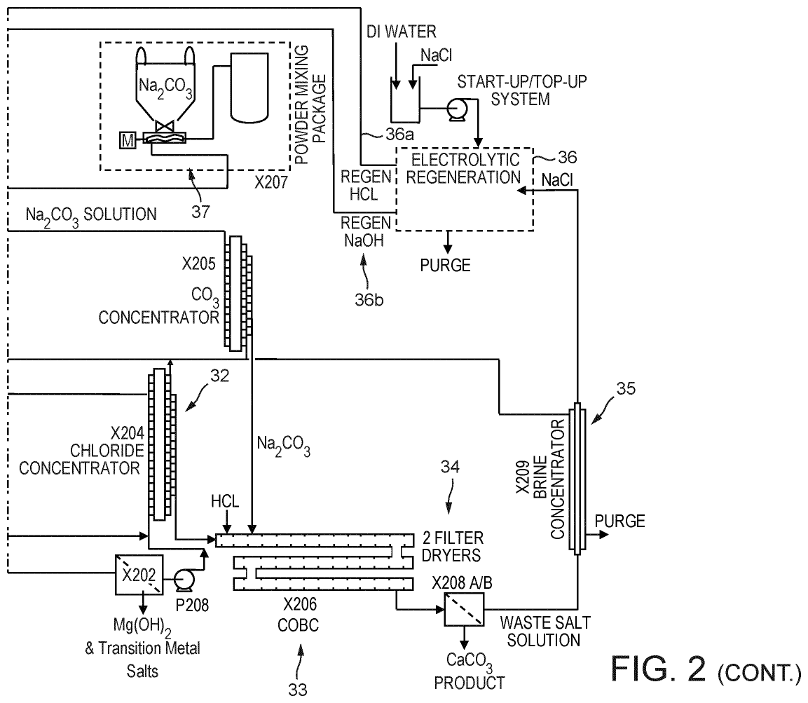

FIG. 1 refers to Phase 1, the separation process.

### A. Phase 1

The system and method used in Phase 1 comprises an eggshell collection vessel, transfer pump /tubing, a separation vessel and collection and drying units for both the eggshell membrane and the eggshell. The whole system contains water. This water contains an acid aqueous medium created by mineral components or enzyme (carbonic anhydrase) which is able to maintain the pH at a slightly acid level.

Eggshells are received into the collection vessel (1) from the conveyer from an egg processor's egg breaking machine (at up to 27 eggshells/second). Depending on the type and layout of the processor's egg breaking machine, the eggshells tumble directly or are taken by belt conveyer into the eggshell collection vessel. The vessel is placed close to the conveyer, to reduce damage to the shell's integrity.

The collection vessel contains slightly acidified aqueous medium. This provides a bactericidal effect, reducing the potential for bacterial contamination, while also acting upon the exposed calcium carbonate of the papillae of the shell/membrane interface, removing the calcium carbonate of the mammillae layer of the eggshell, releasing the membrane from the shell.

At the base of the collection vessel there is an auger (2). The spacing between the vanes of the auger measure a distance a specific percentage larger than the average egg. It is running at a speed such that individual shells fall into the space between the vanes. This separates the eggshells as they move forward, allowing the shells to progress separately to the next stage of the process.

The auger is connected to a progressive cavitation pump (3). A progressive cavity pump utilises an asymmetric action to move materials forward. It both gently compresses and releases the shells, providing a gentle massaging effect on the shells. This can provide sufficient mechanical intervention on the shell to crack the shell and expose the shell membrane interface at multiple sites to the acid allowing it to act on the eggshell mammillae layer and disrupt the connection between the shell and membrane.

It should be noted that whilst this process will disconnect the inner membranes of the shell, it will not disrupt the cuticula on the outside of the eggshell, nor the protein matrix within the shell.

The transfer tubing's (4) geometry and path are designed to additionally exert pressure/shear force on the shells to continue the separation process of any unseparated shell and membrane.

The transfer tube empties into a settling tank (5) containing separated eggshell particles and large pieces of eggshell membrane after the action of the acidified water having disrupted the linkage between the shell and membrane.

The settling tank comprises a structure with a multitude of parallel vanes (6) set at a tangential angle. The tubing delivers membranes and eggshells, below the water level yet above the vanes, onto which they fall. Water is circulated through the vanes at a slow rate that ensures that the light membrane (whose density is very similar to water) stays in suspension, while being insufficient to carry the heavy shell, which drops to the floor of the settling tank.

Pieces of eggshell separated from the membrane are carried away using an auger (7) and progressive cavity pump (8). This material is exposed to a large pore size screen (9) which retains the shell and allows the water to flow through. This liquid is returned to the beginning of the process (1), via a filtration system (16), which collects small particles of shell and also any eggshell membrane or egg albumin that may have been carried over.

Collected pieces of eggshell are passed onto a size reduction system (10) to give a consistent size. The system (10) can be a crosscut shredder which reduces the particle size to between about 2-4 mm. Use of pieces of eggshell having a consistent size gives advantages in terms of consistent behaviour and reaction times when contacted with the hydrochloric acid later in the process.

This material is dewatered and dried, typically using a Nutsche filter system or other system that can be maintained hygienic (11). It is then bagged and sent to Phase 2 of the process.

Water at the top of the settling tank, containing eggshell membrane, is transferred to a membrane collection tank.

The membrane collection tank (13) comprises a tank containing acidified water and a suitable vaned collection device. Acidification is achieved and maintained through the bubbling of CO₂ through the water. This lifts the membrane to the top of the tank where the vanes on the collection device lift them away from the water and into a collection system, comprising a large-pored screen to collect the large membrane pieces.

The collected membrane pieces may be dried if desired. The collected membrane pieces can be packed and then used in a variety of different applications.

This material is dewatered and dried, typically with a vacuum drum or Nutsche filter (14). The resultant liquid is returned to the beginning of the process (1), via a filtration system (16), which collects small particles of shell and also any eggshell membrane or egg albumin that may have been carried over.

Water is removed from the bottom of the tank and returned to the beginning of the process, via a pump (12) and a filtration system (16), which collects small particles of shell and also any eggshell membrane or egg albumin that may have been carried over.

The system requires water but is essentially a closed system. As such, the method and system require much reduced levels of water than an open/batch system.

The pieces of eggshells that are separated from the membrane are collected. The pieces may be subjected to some form of comminution to produce pieces of a desired and consistent size ready for the purification steps.

### B. Phase 2

Clean eggshells from phase A are deposited in a dispensing hopper (20). The eggshells are transferred, using an auger and pump or a conveyor (21) into a reaction vessel (22). The reaction vessel will be constructed of suitable material to resist hydrochloric acid.

The eggshells will be dissolved with HCl, which is added to the tank (22) at inlet (24) from a line containing regenerated material (39a) and diluted with water collected throughout the process through the concentration and dewatering of process solutions and output chemicals (32/35). A stock of concentrated acid is held to maintain the required level of acidity for the process in a vessel (39)

This mix, at a predetermined concentration (such as less than 1 M), will be sprayed onto the top of the reaction liquid using an acid resistant spray nozzle (24). This will damp down the reaction's propensity to uncontrollably foam.

The reaction that will take place will convert CaCO₃ (solid) to CaCl₂ (solution) and give off CO₂ (gas).

The CO₂ generated will be collected via an outlet (25) and stored (38) using a CO₂ capture device. A capture device (37) will make use of NaOH, generated by electrolytic action upon the concentrated waste saline solution (36) from the forward reaction. Reaction of the CO₂ with the NaOH produces Na₂CO₃, which can be used in the process.

CaCl₂ will be removed from the base of the reaction vessel using a suitable pump system (26/27) and can be passed through a filtration system to collect any remaining biologicals and incompletely processed shell (28). The eluant is passed back into reaction vessel (22). In some cases this filtration step can be omitted, with any such organic impurities being removed later in the process along with the precipitated magnesium hydroxide.

The CaCl₂ solution can be concentrated to a desired value, for example, using an electrodialysis system, providing water which can be used to dilute the input hydrochloric acid (39a), which is returned to the reaction vessel (22). The concentrated CaCl₂ then passes forward in the process. In some cases, the calcium chloride solution is not concentrated.

This solution, concentrated CaCl₂, is collected and subsequently pumped into a continuous oscillatory baffled reactor (COBR) (30), a controlled precipitation instrument, where the addition of NaOH, in a controlled manner from a storage vessel (40) allows the precise precipitation of Mg(OH)₂. Preferably, purified calcium carbonate is precipitated from the aqueous product mixture in a continuous oscillatory baffled crystalliser although other mixing/filter devices can be used.

NaOH can be supplied from regenerated material produced from treating NaCl (36/36b). The use of a COBR is advantageous but not essential. Other types of reaction equipment can be used to add sodium hydroxide to the mixture to form and precipitate unwanted magnesium hydroxide.

Solid Mg(OH)₂, and potentially other impurities can be removed by passing the output of the COBR through a cross-flow filtration system. Other ways to separate the solid magnesium hydroxide can be used. The Mg(OH)₂ can be collected and dried (31).

The eluant of the cross-flow filtration system, CaCl₂, can be concentrated using electrodialysis to a desired value (32). This material is then passed through a continuous oscillatory baffled crystallizer (COBC) instrument (33) where the precise precipitation of CaCO₃ can be achieved, leaving a dilute solution of saline, NaCl. The use of a COBC is advantageous but not essential. Other types of reaction equipment can be used to add sodium carbonate to the mixture to form and precipitate the desired purified calcium carbonate.

For some final uses the CaCO₃ is collected, washed, dewatered and dried under GMP conditions (34). The eluant, containing NaCl can be concentrated using Reverse Osmosis or an electrodialysis system (35) to a desired concentration. Concentrated NaCl is passed on to an electrolytic process (36), producing HCl (36a) and NaOH (36b).

Generated HCl (36a) is returned to the beginning of the process (39a), where it is mixed with stock HCl (39) and water, from reverse osmosis or electrodialysis, throughout the process (29) to provide the dilute acid to be sprayed from (24) spray unit into the reaction vessel (22), dissolving the eggshell as part of a circular process.

Generated NaOH (36b), can re-used to either alter the pH within the COBR process (30), precipitating out the Mg(OH)₂, or to capture the CO₂ produced in the reaction between HCl and the eggshells (22) in the CO₂ capture system (37).

The carbon dioxide capture system collects CO₂ from reaction (22) at the beginning of this process and uses the NaOH generated from the recycling of saline, through electrolysis (36/36b) to generate Na₂CO₃, which will be used to precipitate out the CaCO₃ from COBC reaction (33).

This process is highly sustainable, environmentally friendly and near circular. The vast majority of the process's outputs can either be sold commercially or any co-products are re-utilised within the process

The invention relates to an apparatus for separating eggshells and eggshell membranes which produces pharmaceutical grade calcium carbonate, whilst re-utilising the majority of major output chemicals.

The purified calcium carbonate is sufficiently pure to be used in a variety of applications, such as in the preparation of pharmaceutical products. Typically the purified calcium carbonate satisfies the purity requirements in the European Pharmacopoeia (Ph. Eur.).

The purified calcium carbonate may exist in various forms such as polymorphs. The purified calcium carbonate may be calcite, aragonite or vaterite, preferably calcite.

Phase 2 of the invention has been described above in relation to eggshells. However, other forms of biogenic calcium carbonate material may be used, such as other form of avian eggshells, marine biogenic material or mollusc shells. The marine biogenic calcium carbonate material may comprise sea shells, such as cockles, mussels and oysters. The marine biogenic calcium carbonate material may comprise crustaceans, such as lobster shells, crabs, prawns and shrimp. The biogenic calcium carbonate material may comprise other molluscs such as snails. The biogenic calcium carbonate material may be fresh (for example from the recent harvesting of live animals) or may instead be obtained from older sources of material. The biogenic calcium carbonate may be fossil calcium carbonate material.

Instead of using eggshell (which has been separated from membrane), the invention can be applied to such other biogenic calcium carbonate materials. This material may be subjected to some form of comminution to produce pieces of a desired size before being contacted with hydrochloric acid at the start of the reaction process.

Calcium carbonate material that can be used in the invention may come from a wide range of sources. These include industrially derived materials, which may be as a result of:
a) mining activities, as would be seen in the products produced by companies such as Longcliffe (Longcliffe Quarries Ltd),
b) re-carbonised precipitated materials, which may come from a company such as Mineral Technologies (Mineral Technologies Pty Ltd), or
c) material that is generated as a side product in another chemical process.

Sources of suitable calcium carbonate material are not limited to the examples above.

There is disclosed an apparatus for separating eggshells from eggshell membranes, comprising a device for the separation of eggshell from their membranes whereby the process maintains the large size of the eggshell membrane, with an output of large pieces of membrane and eggshell fragments, comprising a tank containing parallel tangentially placed vanes to receive and separate the physically separated membrane and eggshell, making use of their different densities. The apparatus utilizes a water based medium that is treated with acid, CO₂ and the enzyme, carbonic anhydrase (commercially available—for example from the Sigma Chemical Company) to produce a controlled level of acidity, which actively enhances the cleavage of the shell from the membrane.

The apparatus may further include an auger, which is used to separate the collected eggshells and hold them separately in the water medium whilst moving them forward. The auger can be used to separate the collected eggshells and hold them separately in the water medium whilst moving them forward. The auger can be connected to a Progressive Cavity Pump, which massages the shells to promote the release large pieces of membrane from the shell. The process allows the action of the acidified medium on the exposed junction between the shell and the membrane. The pH of the aqueous medium can be controlled by the use of acid, CO₂ and the enzyme carbonic anhydrase.

The apparatus can comprise a settling tank containing parallel and tangential vanes. The parallel and tangential vanes can be located below the outlet of separated shell and membrane. The outlet can be located below the surface of the water contained in the tank. The vanes allow separation of the shell and membrane in the water flow over the vanes. The apparatus allows the removal of clean eggshell via an auger and progressive cavity pump at its base. The apparatus allows the removal of membrane to a collection tank, via a suitable tube and pump combination.

The tank can contains water that is aerated with CO₂. The water provides a substrate for the acid or enzyme, carbonic anhydrase, to control the pH at a slightly acidic pH. The acid or enzyme which acts upon the whole eggshell to aid release of the shell from the membrane. The CO₂ infused water at an acidic pH acts as a bactericide/bacteria, virus inhibitor, maintaining the hygiene of the tank.

The apparatus can comprise a coarse screen to dewater the clean eggshell. The apparatus can collect and dewater the membrane detached from the eggshells. The waste-water recovered from the process can be reused, as an input reagent. The waste-water can be cleaned through the use of differentially sized filters. This process can collect small membrane and albumin fragments from the waste-water.

The apparatus and method can purify eggshells into pharmaceutical grade calcium carbonate.

The apparatus can comprise a vessel to breakdown eggshells. The vessel can break down eggshell slurry through exposure to HCl. The HCl used can be regenerated in the process.

The method of the invention can make up HCl reaction solutions with water taken from the eluant streams of the reaction vessels.

The apparatus can spray hydrochloric acid into the reaction vessel, to subdue foaming. An impellor can be used to assist and ensure mixing and full dissolution of the eggshells into a solution of CaCl₂.

The apparatus can reuse the output chemicals from the reaction vessel. The apparatus can perform a filtration step which filters the reaction vessel's output, returning the water to the reaction vessel.

The filtration step produces a solution of CaCl₂. The solution of calcium chloride can be concentrated using suitable equipment. The water resulting from such a concentration step can be reused in making up hydrochloric acid for the reaction with the eggshells.

The apparatus and method of the invention can remove contaminating metals in converting the eggshells (or other biogenic calcium carbonate material) into purified calcium carbonate.

The apparatus can cause precipitation of Mg(OH)₂ through the controlled addition of a base chemical, preferably as sodium hydroxide solution. Other factors that influence the precipitation include the control of temperature, the control of flow rates, the control of reaction chemical concentrations, and/or the control of process chemical concentrations. Preferably, the invention uses regenerated NaOH to cause the precipitation of Mg(OH)₂.

The apparatus removes the precipitated Mg(OH)₂ from the output of the precipitation apparatus, leaving a solution of CaCl₂. The method and apparatus can concentrate the CaCl₂ solution. Water generated that this stage can be re-used in the reaction of the eggshells with hydrochloric acid.

The apparatus and method can produce pharmaceutical grade calcium carbonate. An apparatus and method can cause the formation and precipitation of CaCO₃ through the controlled addition of Na₂CO₃. Factors that affect the precipitation of calcium carbonate can include the control of temperature, the control of flow rates, the control of reaction chemical concentrations, and/or the control of process chemical concentrations.

The apparatus and method can use regenerated Na₂CO₃ to cause the precipitation of CaCO₃.

Preferably, the Na₂CO₃ used in the invention is produced from recycling co-products.

The apparatus and method can convert the NaCl produced through the reaction of hydrochloric acid with the eggshells (or other biogenic calcium carbonate material) into regenerated HCl and regenerated NaOH, through the application of electricity.

The process above has been described with reference to certain chemicals for illustration of the invention. However, the process is not limited to the specific chemicals mentioned above.

In the initial membrane detachment phase the enzyme preferred is carbonic anhydrase but a number of alternative enzymes may be employed to selectively target different protein linkages such as bromelains, papains or pepsins to aid in the membrane release.

The impure calcium carbonate material can be contacted with a suitable aqueous acid, preferably hydrochloric acid, but this can also be another mineral acid such as nitric acid or an organic acid such as citric, formic, tartaric or ethylenediamine tetraacetic acid. This step produces carbon dioxide and an aqueous product mixture comprising a calcium salt, preferably calcium chloride.

An aqueous base is then added to the aqueous product mixture, such as potassium hydroxide, sodium hydroxide or ammonium hydroxide, the only requirement being that it produces magnesium hydroxide in the process but is preferably sodium hydroxide. This allows the removal of magnesium and any remaining residual membrane pieces from the mixture by sedimentation or filtration.

A carbonate source is then added to the aqueous product mixture to produce calcium carbonate and a salt by-product. The carbonate source can be potassium, sodium or ammonium but preferably the carbonate source is sodium carbonate. The salt by-product is preferably sodium chloride.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. (canceled)

2. (canceled)

3. (canceled)

4. (canceled)

5. A method of producing purified calcium carbonate comprising the steps of;
providing impure calcium carbonate material,
contacting the impure calcium carbonate material with an aqueous acid to produce carbon dioxide and an aqueous product mixture comprising a calcium salt,
adding an aqueous base to the aqueous product mixture,
adding a carbonate source to the aqueous product mixture to produce calcium carbonate and a salt by-product, and
precipitating purified calcium carbonate.

6. A method according to claim 5 wherein the aqueous acid is hydrochloric acid, the calcium salt is calcium chloride, the aqueous base is sodium hydroxide, the carbonate source is sodium carbonate and the salt by-product is sodium chloride.

7. A method according to claim 5 wherein the salt by-product produced by the addition of the carbonate source is used to generate the aqueous base and the aqueous acid.

8. A method according claim 5 wherein carbon dioxide produced by contacting the impure calcium carbonate material with the acid is reacted with a base to generate the carbonate source.

9. A method according to claim 5 wherein impurities are precipitated and/or filtered from the aqueous product mixture; preferably precipitated in a continuous oscillatory baffled reactor.

10. A method according to claim 5 wherein purified calcium carbonate is precipitated from the aqueous product mixture in a continuous oscillatory baffled crystalliser.

11. A method according to claim 5 wherein the impure calcium carbonate material comprises biogenic calcium carbonate material; preferably wherein the biogenic calcium carbonate comprises avian eggshells, marine biogenic material, mollusc shells or fossil biogenic material; more preferably wherein the marine biogenic material comprises mollusc shells and/or crustacean shells.

12. A method according to claim 11 wherein the avian eggshells are chicken eggshells.

13. A method according to claim 11 wherein the avian eggshells are produced according to the method of claim 1.

14. (canceled)

15. An apparatus for producing purified calcium carbonate from impure calcium carbonate material, comprising a vessel for contacting the impure calcium carbonate material with an aqueous acid to produce carbon dioxide and an aqueous product mixture comprising a calcium salt, means for adding an aqueous base to the aqueous product mixture, means for adding a carbonate source to the aqueous product mixture to produce calcium carbonate and a salt by-product, and means for precipitating purified calcium carbonate.
